(19) United States
(12) Patent Application Publication
(10) Pub. No.: US 2026/0310163 A1
(43) Pub. Date: Oct. 8, 2026

(54) Device And Method For Compiling A Dataset For The Manufacture And Installation Of A Wiring Harness

(71) Applicant: Lisa Dräxlmaier GmbH, Vilsbiburg (DE)

(72) Inventors: Christian MAIER, Bodenkirchen (DE); Stefan Perzl, Schwindegg (DE); Joannis Panos, Esslingen am Neckar (DE)

(73) Assignee: Lisa Dräxlmaier GmbH, Vilsbiburg (DE)

(21) Appl. No.: 19/108,154

(22) PCT Filed: Sep. 1, 2023
(86) PCT No.: PCT/EP2023/074059

§ 371 Date: Mar. 1, 2025

(30) Foreign Application Priority Data
Sep. 5, 2022 (DE) 102022122387.6

(51) Int. Cl. G05B 19/4097; H01B 7/00

(52) U.S. Cl. CPC G05B 19/4097; G05B 2219/35134; H01B 7/0045

(57) ABSTRACT

An apparatus for creating a data set for a manufacturing system for manufacturing a wire harness for a vehicle and for an assembly and/or installation system for assembling the wire harness in the vehicle is set out herein. The wire harness comprises a plurality of wire harness components. The apparatus comprises a processor means adapted to create the data set based on virtual 3D models of the plurality of wire harness components of the wire harness and a virtual 3D model of the wire harness. The apparatus further comprises a communication interface configured to provide the data set of the manufacturing facility and the assembly system. The data set comprises first data, which is configured such that the manufacturing system manufactures the wire harness on the basis of the first data. The data set comprises second data, which is configured such that the assembly system assembles and/or installs the wire harness in the vehicle on the basis of the second data.

### CROSS REFERENCE TO RELATED APPLICATIONS

This application is a national stage entry of international application PCT/EP2023/047059, filed Sep. 1, 2023, which claims priority to German patent application 10202212387.6, filed Sep. 5, 2022, the content of the both of which is incorporated herein by reference.

### BACKGROUND OF THE INVENTION

### Field of the Invention

The present invention relates to the manufacture and installation of electrical wiring harnesses. In particular, the invention relates to devices, methods and a system for creating a data set for the automated production of a wiring harness for a vehicle and for the automated installation of the wiring harness in the vehicle.

Wire harnesses (also known as cable harnesses) are used in numerous products and branches of industry to connect electrical components so that the electrical components can be supplied with power and/or communicate with each other, for example. In automotive engineering in particular, sometimes complex cable harnesses are installed as components of vehicle electrical systems in motor vehicles, airplanes, trains and the like. Such wiring harnesses can be highly complex, in particular with numerous cables, connectors, holding devices for fastening in the vehicle and the like.

### Description of Related Art

Up to now, the production and installation or assembly of wire harnesses has only been partially automated, if at all. This is due in particular to the fact that different data may be required for different sub-processes of production and assembly. For example, product data such as 3D geometry data of the wire harness and/or the wire harness components, process data such as processing steps of a wire of the wire harness and resource data such as information on systems for the production and/or assembly of the wire harness are used. This data is often still generated manually and may not be available digitally, only incompletely and/or in different formats or data models, and has therefore not yet been used to automate the production and assembly of a wire harness.

The task is therefore to realize a device, a method and a system in order to efficiently determine and provide a data set for the essentially automated production and assembly of a cable set.

This problem is solved by the features of the independent patent claims. Advantageous embodiments are the subject of the figures, the description and the dependent patent claims.

### BRIEF SUMMARY OF THE INVENTION

According to a first aspect, the invention relates to a device for creating a data set for a production system for the automated production of a wiring harness for a vehicle and for an assembly system for the automated assembly of the wiring harness in the vehicle. The wire harness comprises a plurality of wire harness components. In particular, the plurality of wiring harness components may comprise a plurality of connectors, a plurality of electrical leads for connecting the plurality of connectors, a plurality of housing receptacles and/or a plurality of holding devices. A connector may, for example, have an electrical contact part which may be surrounded by a connector housing, in particular made of plastic.

The apparatus comprises a processor means adapted to create the data set based on virtual 3D models of the plurality of wire harness components of the wire harness and a virtual 3D model of the wire harness. In other words, the processor means is adapted to fuse the virtual 3D models of the plurality of wire harness components and the virtual 3D model of the wire harness into a single data set.

The device also comprises a communication interface which is designed to provide the data set of the production system, in particular a control device of the production system, and the assembly system, in particular a control device of the assembly system.

The data set comprises first data, which is designed in such a way that the production system automatically manufactures the wiring harness on the basis of the first data. The data set also comprises second data, which is designed in such a way that the assembly system automatically assembles or installs the wiring harness in the vehicle on the basis of the second data.

This means that the data set can be used for both automated production and automated assembly of the wire harness. Furthermore, the wire harness can be represented using a consistent data model and a consistent flow of information can be ensured. This makes it possible, for example, to efficiently monitor and optimize the process quality and production quality of the wire harness.

For automated production of the wire harness, the production system can, for example, comprise at least one automatic machine or robot. The at least one automatic machine of the production system can, for example, comprise an automatic placement machine and/or an automatic winding machine, which is controlled in particular by the control device of the production system.

For automated assembly of the wiring harness, the assembly system can, for example, comprise at least one automatic machine or assembly robot for assembly, i.e. for installing the wiring harness in the vehicle. The at least one automatic machine of the assembly system can be controlled in particular by the control device of the assembly system.

The data set can, for example, be generated based on product data and/or process data of the wire harness, which can, for example, be transmitted to the communication interface by the assembly system, in particular the control device of the assembly system. Furthermore, the data set can, for example, be generated based on resource data of the production system, which can, for example, be transmitted to the communication interface by the production system, in particular the control system of the production system.

The product data can, for example, include information about a housing position of a housing surrounding the wire harness to be manufactured, in particular a 3D geometry. The product data can also include, for example, information about chamber assignments of the wire harness to be manufactured. Chambers can be part of the housing and correspond to predefined spaces that accommodate and hold a contact part and leads of the wire harness.

The process data can, for example, include information about the insertion widths, insertion depths and insertion heights of the wires to be inserted into the wire harness. Furthermore, the process data can also include, for example, information about a back pull test and/or processing of the power set, in particular by cutting, crimping and/or soldering processes carried out by the production system.

The resource data can include, for example, information about supported placement pallets, available tools and information about one or more automatic machines of the production system, in particular the automatic placement machine and/or an automatic winding machine.

According to one embodiment, the processor device is designed to generate the second data on the basis of the first data or to semantically link the second data to the first data. The processor device can be designed to implement an ontology module which is designed to generate the second data on the basis of the first data or to semantically link the second data to the first data.

The ontology module can be used to semantically link, in particular network, all the different proprietary data models of, for example, individual units of the production system and/or the assembly system of a vehicle manufacturer. This enables a continuous exchange of information between all proprietary data models without the need to provide individual interfaces at system level. Instead, the semantic networking achieved with the ontology module enables the data models to be mapped in an overarching digital model, a so-called digital twin, by means of which a bidirectional harmonized data stream between all units of the production system and all units of the assembly system is enabled without additional hardware effort at system level. In particular, completely different proprietary data models from the areas of product development, production and assembly can be networked.

For example, ontology-forming class structures can be specified in the ontology module, which have classes structured hierarchically or in associations, by means of which a semantic networking of the proprietary data models can be carried out. Classification is advantageously carried out using metamodels that are structured in ontology libraries. These ontologies can be used to configure the semantic networking of the proprietary data models. This enables flexible data mapping of all proprietary data models According to one embodiment, the first data defines a reference position of the wire harness and the positions and/or orientations of the plurality of wire harness components relative to the reference position of the wire harness.

According to one embodiment, the second data defines a reference position of the vehicle and the position and/or orientation of the wiring harness relative to the reference position of the vehicle.

This allows the vehicle manufacturer's assembly system to efficiently install the wiring harness in the vehicle, for example, eliminating the need to calibrate an automatic assembly system.

According to one embodiment, the first data and/or the second data define one or more process parameters of the manufacturing system and/or the assembly system.

For example, the one or more process parameters may comprise parameters for the manufacturing process of the wire harness by the at least one automatic machine of the manufacturing system, in particular the automatic placement machine and/or the automatic winding machine. For example, the one or more process parameters may comprise parameters for the assembly process of the wire harness by the automatic machine of the assembly system.

According to one embodiment, the communication interface is designed to provide the data record of the production system and/or the assembly system via a communication network or to store the data record on a portable data carrier and to provide the portable data carrier to the production system and/or the assembly system.

Depending on the requirements, this allows the data record to be transmitted to the production system and/or the assembly system in a particularly secure and/or particularly delay-free manner.

The portable data carrier can, for example, be a mechanically lockable data carrier, in particular a USB stick. The communication network can, for example, be implemented via a cloud server, which in particular implements a cloud application.

According to a second aspect or embodiment, the invention relates to a system for manufacturing a wiring harness for a vehicle and for mounting the wiring harness in the vehicle. The system comprises a device according to the first aspect for creating a data set, a production system for automated production of a wire harness on the basis of the data set and an assembly system for automated assembly of the wire harness in the vehicle.

According to a third aspect, the invention relates to a method for creating a data set for a manufacturing system for automated manufacturing of a wire harness for a vehicle and for an assembly system for automated assembly of the wire harness in the vehicle, wherein the wire harness comprises a plurality of wire harness components. The method comprises creating the data set on the basis of virtual 3D models of the plurality of wire harness components of the wire harness and a virtual 3D model of the wire harness and providing the data set to the manufacturing system and to the assembly and/or installation system, wherein the data set comprises first data which are designed such that the manufacturing system automatically manufactures the wire harness on the basis of the first data, and wherein the data set comprises second data which are designed such that the assembly system automatically assembles or installs the wire harness in the vehicle on the basis of the second data.

### BRIEF DESCRIPTION OF THE SEVERAL VIEWS OF THE DRAWINGS

Further advantages, features, and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure.

The embodiments mentioned for the subject matter of the first aspect are also embodiments for the subject matter of the second aspect and the third aspect.

Further advantages and details of the invention are explained in more detail by way of example with reference to the embodiments shown in the schematic figures, wherein:

FIG. 1 depicts a block diagram of a system according to one embodiment for manufacturing a wiring harness for a vehicle and for mounting the wiring harness in the vehicle;

FIG. 2 depicts a schematic of an exemplary set of cables; and

FIG. 3 depicts a flow chart showing a method according to one embodiment for creating a data set for a production system for manufacturing a wiring harness for a vehicle and for an assembly system for assembling the wiring harness in the vehicle.

The figures are merely schematic representations and serve only to explain the invention. Identical or similarly acting elements are consistently provided with the same reference signs.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C.

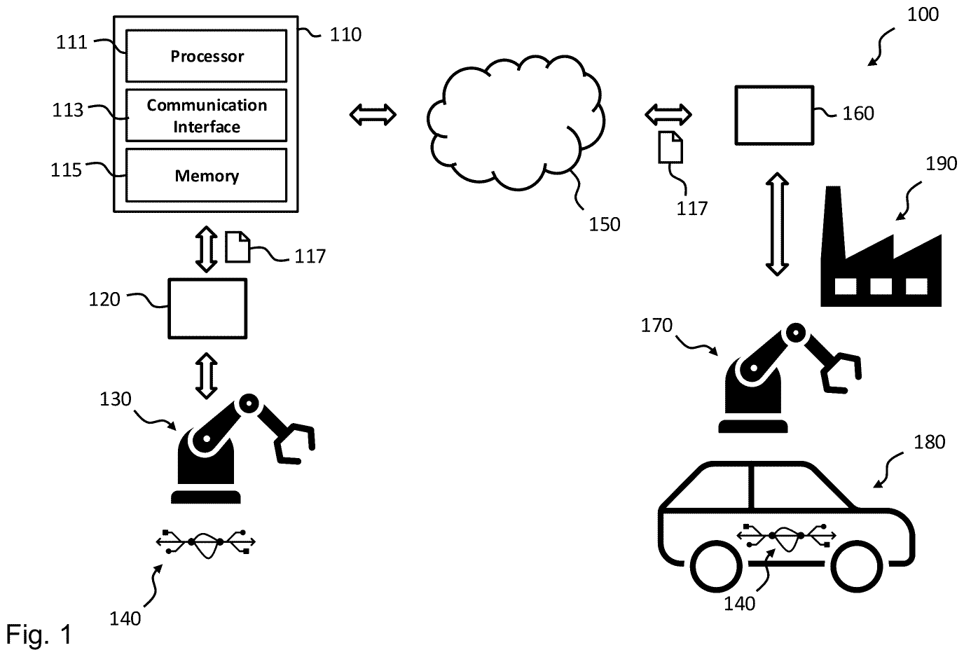

FIG. 1 depicts a schematic block diagram of a system 100 for manufacturing a wiring harness 140 for a vehicle 180, in particular a passenger car 180, and for mounting or installing the wiring harness in the vehicle 180. As the skilled person will recognize, the components of the system 100 described below do not necessarily have to be used at a common manufacturing site, but can also be operated remotely from each other. Some or all of the components of the system 100 described below may be connected to each other or to a central device 110 via a communication network 150 to enable communication with each other or communication with the central device 110. The device 110 is configured to create a data set 117 for a manufacturing plant or system 120, 130 for automated manufacturing of the wire harness 140 for the vehicle 180 and for an assembly system 160, 170 for automated assembly of the wire harness 140 in the vehicle 180. The communication network 150 may comprise a local communication network such as a corporate network and/or a global communication network such as the Internet. The manufacturing system 120, 130 is configured for automated manufacturing of the wire harness 140 based on the data set 117 and the assembly system 160, 170 is configured for automated assembly of the wire harness 140 in the vehicle 180 based on the data set 117.

FIG. 1 shows the device 110, which can communicate with a control device 120 of the manufacturing plant 120, 130 and with a control device 160 of the assembly plant 160, 170 of a vehicle manufacturer 190 (also referred to as OEM 190). For this purpose, the device 110 comprises a communication interface 113. The device 110 further comprises a processor device 111 and may comprise a non-volatile memory 115. The non-volatile memory 115 may be configured to store data and executable program code which, when executed by the processor device 111 of the device 110, causes the processor device 111 to perform the functions, operations and methods described below.

Even if this is not shown in FIG. 1, the control device 120 of the manufacturing system 120, 130 and the control device 160 of the assembly system 160, 170 can accordingly also have communication interfaces for communication and processors and memories for data processing.

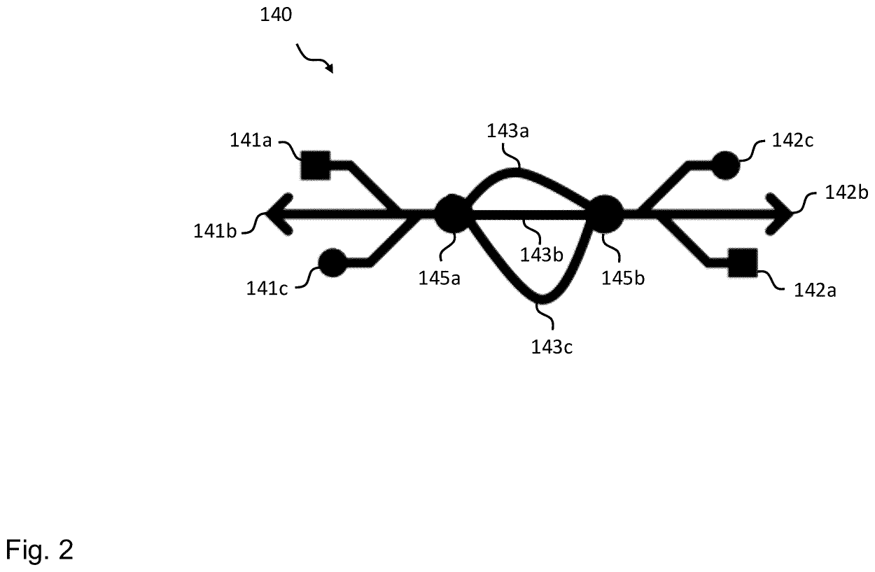

The processor device 111 of the apparatus 110 is adapted to create the data set 117 based on virtual 3D models of a plurality of wire harness components of the wire harness 140 and a virtual 3D model of the wire harness 140. In other words, the processor device 111 is configured to fuse the virtual 3D models of the plurality of wire harness components of the wire harness 140 and the virtual 3D model of the wire harness 140. As shown in more detail in FIG. 2, the plurality of wire harness components of the wire harness 140 may include, in particular, a plurality of connectors 141a-c, 142a-c, a plurality of electrical leads 143a-c for connecting the plurality of connectors 141a-c, 142a-c, a plurality of housing receptacles and/or a plurality of retaining devices 145a,b.

The communication interface 113 of the device 110 is designed to provide the data set 117 to the manufacturing system 120, 130, in particular to the control device 120 of the manufacturing system, and to the assembly system 160, 170, in particular to the control device 160 of the assembly system.

The data set 117 comprises first data, which is configured such that the manufacturing system 120, 130 automatically manufactures the wire harness 140 based on the first data. The data set 117 further comprises second data configured such that the assembly system 160, 170 automatically assembles or installs the wire harness 140 in the vehicle 180 based on the second data.

The data set 117 can, for example, be generated based on product data and/or process data of the wire harness 140, which can, for example, be transmitted to the communication interface 113 by the assembly system 160, 170, in particular the control device 160 of the assembly system 160, 170. Furthermore, the data set 117 can, for example, be generated based on resource data of the production system 120, 130, which can, for example, be transmitted to the communication interface 113 by the production system 120, 130, in particular the control device 120 of the production system 120, 130.

The product data may, for example, comprise information about a housing position of a housing surrounding the wire harness 140 to be manufactured, in particular a 3D geometry. The product data may further comprise, for example, information about chamber assignments of the wire harness 140 to be manufactured. Chambers may be part of the housing, and may correspond to predefined spaces that receive and retain a contact part and the electrical leads 143a-c of the wire harness 140.

The process data may include, for example, information about mating widths, mating depths and mating heights of the electrical wires 143a-c of the power set 140 to be mated. Further, the process data may include, for example, information about a back pull test and/or processing of the power set 140, in particular cutting, crimping, soldering and/or additional winding processes that may be performed by the manufacturing system 120, 130.

The processor device 111, in particular an ontology module implemented by the processor device 111, can be designed to generate the second data on the basis of the first data or to semantically link the second data with the first data. In particular, the ontology module may further be designed to semantically link the second data with the first data and/or to semantically link the product data, the process data and the resource data.

The ontology module can be used to semantically network all the different proprietary data models of, for example, individual units of the production system 120, 130 and/or the assembly system 160, 170 of the vehicle manufacturer 190. This enables a continuous exchange of information between all proprietary data models without the need to provide individual interfaces at system level. Instead, the semantic networking achieved with the ontology module makes it possible to map the data models in an overarching digital model, a so-called digital twin, by means of which a bidirectional harmonized data stream between all units of the production system 120, 130 and the assembly system 160, 170 of the vehicle manufacturer 190 is made possible without additional hardware effort at system level. In particular, completely different proprietary data models from the areas of product development, production and assembly can be networked.

For example, ontology-forming class structures can be specified in the ontology module, which have classes structured hierarchically or in associations, by means of which a semantic networking of the proprietary data models can be carried out. Classification is advantageously carried out using metamodels that are structured in ontology libraries. These ontologies can be used to configure the semantic networking of the proprietary data models. This enables flexible data mapping of all proprietary data models. Further details of the ontology module according to a preferred embodiment can be found in DE 10 2019 128 104 A1, to which reference is hereby made in full.

The first data may define a reference position of the wire harness 140 and the positions and/or orientations of the plurality of wire harness components relative to the reference position of the wire harness 140. Further, the second data may define a reference position of the vehicle 180 and the position and/or orientation of the wire harness 140 relative to the reference position of the vehicle 180. Further, the first data and/or the second data may define one or more process parameters of the manufacturing system 120, 130 and/or the assembly system 160, 170.

The communication interface 113 may be configured to provide the data set 117 to the manufacturing system 120, 130 and/or the assembly system 160, 170 via the communication network 150 or to store the data set 117 on a portable data carrier and provide the portable data carrier to the manufacturing system 120, 130 and/or the assembly system 160, 170.

The control device 120 of the manufacturing system 120, 130 can be designed to receive the data set 117 and to control the at least one automatic placement machine 130 of the manufacturing system 120, 130. The manufacturing system 120, 130, in particular the at least one automatic placement machine 130, can be designed to manufacture the wire harness 140 on the basis of the data set 117. In addition to the control device 120 and the automatic placement machine 130, the manufacturing system 120, 130 may further comprise an automatic winding machine which tapes the wire harness 140 after partial production by the automatic placement machine 130.

In one embodiment, the control device 120 of the manufacturing system 120, 130 may be configured to transmit the resource data to the device 110, which may include, for example, information about supported placement pallets, available tools, and information about the placement machine(s) 130 of the manufacturing system 120, 130

The control device 160 of the assembly system 160, 170 of the vehicle manufacturer 190 can be designed to control an assembly of the wiring harness 140 in a vehicle 180, in particular passenger car 180, by an automatic machine or assembly robot 170 of the assembly system 160, 170 based on the data set 117.

The central device 110 can be designed to control the production of the wire harness 140 based on the resource data from the control device 120 of the production system 120, 130 and the product data and the process data from the control device 160 of the assembly system 160, 170. For this purpose, the central device 110 can be designed to transmit the data set 117 to the control device 120 of the manufacturing system 120, 130, which can define manufacturing work steps, for example executable program code for the at least one automatic placement machine 130 of the manufacturing system 120, 130, and/or manufacturing components.

In a further embodiment, the device 100, which may for example be designed as an industrial PC 100, may further comprise a display device not shown in FIG. 1. For example, the display device may be configured to display the virtual 3D models of the plurality of wire harness components of the wire harness 140 and/or the virtual 3D model of the wire harness 140.

FIG. 2 shows a schematic representation of the wire harness 140 produced on the basis of the data set 117. The data set 117 can cause the automatic placement machine 130 of the production system 120, 130 or instruct a user of the automatic placement machine 130 to first mount so-called holding devices at defined positions on the placement pallet and then insert connectors 141a-c, 142a-c of the same type or different types into the individual holding devices. The pick-and-place machine 130 can then be designed to connect the electrical lines 143a-c to the plug connectors 141a-c, 142a-c. The plug connectors 141a-c, 142a-c can have a number of pins and/or contact parts corresponding to the number of electrical lines 143a-c or a different number.

Furthermore, the manufacturing system 120, 130 may comprise one or more further units and/or devices (not shown), such as a device for cutting the electrical leads 143a-c, a device for attaching electrical contact parts and/or an automatic crimping machine. In a further embodiment, these further units and/or devices may also be integrated into the automatic placement machine 130.

The electrical cables 143a-c connected to the plug connectors 141a-c, 142a-c can then be removed from the assembly pallet and laid out on a building board (also known as an assembly aid), in particular manually or automatically. The electrical cables 143a-c can then be further processed. This may include wrapping the electrical leads 143a-c (also referred to as taping) with a material by the automatic winding machine, at least in sections, in order to bundle a plurality of electrical leads 143a-c.

In a further embodiment, the electrical leads 143a-c can alternatively and/or additionally be further processed on the placement pallet, in particular wrapped or bandaged with a material by the automatic winding machine at least in sections, in order to bundle a plurality of electrical leads 143a-c.

Furthermore, holding devices 145a-b can be attached to certain positions of the electrical cables 143a-c. In particular, the holding devices 145a-b can be designed differently, for example as a support for the electrical cables 143a-c and/or as a holder for the plug connectors 141a-c, 142a-c. In this way, a wire harness 140 with a defined 3D structure is created based on the data set 117, which can be installed in the vehicle 180

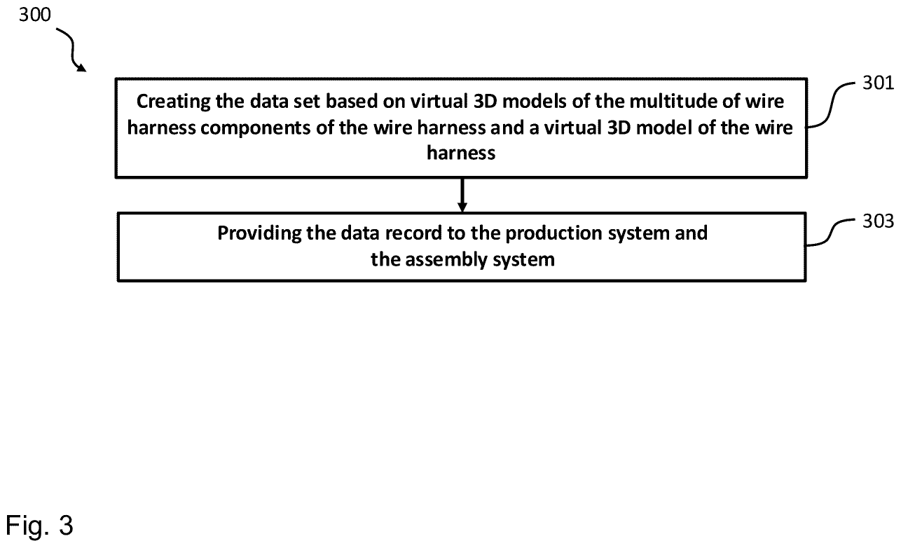

FIG. 3 shows in a flowchart a method 300 for creating the data set 117 for the production system 120, 130 for automated production of the wire harness 140 for the vehicle 180 and for the assembly system 160, 170 for automated assembly of the wire harness 140 in the vehicle 180.

The method 300 includes a step 301 of creating the data set 117 based on 3D virtual models of the plurality of wire harness components of the wire harness 140 and a 3D virtual model of the wire harness 140.

The method 300 further comprises a step 303 of providing the data set 117 to the manufacturing facility 120, 130 and to the assembly facility 160, 170, wherein the data set 117 comprises first data configured such that the manufacturing facility 120, 130 automatically manufactures the wire harness 140 based on the first data, and wherein the data set 117 comprises second data configured such that the assembly facility 160, 170 automatically assembles or installs the wire harness 140 in the vehicle 180 based on the second data.

It should also be noted that “comprehensive” does not include any other elements or steps. and “one” or “a” does not exclude a plurality. Furthermore, it should be noted that features or steps described with reference to one of the above embodiments may also be used in combination with other features or steps of other embodiments described above. Reference signs in the claims are not to be regarded as a limitation.

What is claimed is:

1. An apparatus configured to create a data set configured to support for a manufacturing system for manufacturing a wire harness for a vehicle and for an assembly system for assembling and/or installing the wire harness in a vehicle, wherein the wire harness comprises a plurality of wire harness components, the apparatus comprising:
a processor device configured to create the data set based on virtual 3D models of a plurality of wire harness components of the wire harness and a virtual 3D model of the wire harness; and
a communication interface configured to provide the data set of the manufacturing system and the assembly system;
wherein the data set comprises first data configured such that the manufacturing system manufactures the wire harness based on the first data, and
wherein the data set comprises second data configured such that the assembly system assembles the wire harness in the vehicle based on the second data.

2. The apparatus according to claim 1, further comprising a processor device configured to generate the second data on a basis of the first data or to semantically link the second data with the first data.

3. The apparatus according to claim 2, wherein the processor device is configured to implement an ontology module, configured to generate the second data on the basis of the first data or to semantically link the second data with the first data.

4. The apparatus according to claim 1, wherein the first data defines a reference position of the wire harness and the positions and/or orientations of the plurality of wire harness components relative to the reference position of the wire harness.

5. The apparatus according to claim 1, wherein the second data defines a reference position of the vehicle and the position and/or orientation of the wire harness relative to a reference position of the vehicle.

6. The apparatus according to claim 1, wherein the first data and/or the second data define one or more process parameters of the manufacturing system and/or the assembly system.

7. The apparatus according to claim 1, wherein the communication interface is configured to provide the data set to the manufacturing system and/or the assembly system via a communication network or to store the data set on a portable data carrier and to provide the portable data carrier to the manufacturing system (and/or the assembly system.

8. The apparatus according to claim 1, wherein the plurality of wire harness components comprise a plurality of connectors, a plurality of electrical wires configured and arranged to connect the plurality of connectors, a plurality of housing receptacles and/or a plurality of holding means.

9. A system for manufacturing a wiring harness for a vehicle and for mounting the wiring harness in the vehicle, the system comprising:
an apparatus configured to create a data set configured to support a manufacturing system for manufacturing a wire harness for a vehicle and an assembly system for assembling and/or installing the wire harness in a vehicle, wherein the wire harness comprises a plurality of wire harness components, the apparatus comprising a processor device configured to create the data set based or virtual 3D models of a plurality of wire harness components of the wire harness and a virtual 3D model of the wire harness; and a communication interface configured to provide the data set of the manufacturing system and the assembly system; wherein the data set comprises first data configured such that the manufacturing system manufactures the wire harness based on the first data, and wherein the data set comprises second data configured such that the assembly system assembles the wire harness in the vehicle based on the second data;
a production line configured to produce the wire harness based on the data set; and
a mounting system configured to mount the cable set in the vehicle.

10. A method for creating a data set for a manufacturing system for manufacturing a wire harness for a vehicle and for an assembly system for assembling the wire harness in the vehicle, the wire harness comprising a plurality of wire harness components, the method comprising the steps of:
creating the data set based on 3D virtual models of the plurality of wire harness components of the wire harness and a 3D virtual model of the wire harness; and
provisioning the data set to the production system and to the assembly system; and
wherein the data set comprises first data configured such that the manufacturing system manufactures the wire harness based on the first data, and
wherein the data set comprises second data configured such that the assembly system assembles the wire harness in the vehicle based on the second data.
